(19) United States
(12) Patent Application Publication
(10) Pub. No.: US 2003/0107276 A1
(43) Pub. Date: Jun. 12, 2003

(54) Micro vibrating motor

(75) Inventor: Tsan-Lung Chen, Sanchung City (TW)

Correspondence Address: BACON & THOMAS, PLLC, 625 SLATERS LANE, FOURTH FLOOR, ALEXANDRIA, VA, 22314

(73) Assignee: KOCAM INTERNATIONAL CO., LTD, Taipei (TW)

(21) Appl. No.: 10/006,217

(22) Filed: Dec. 10, 2001

(51) Int. Cl. H02K 7/06; H02K 7/10

(52) U.S. Cl. 310/81

(57) ABSTRACT

The invention is to provide a micro vibrating motor which includes a weight block having a coupling portion thereon to receive a rotary shaft disposed at an end edge of a motor, and a weld portion provided at the connecting edges of the coupling portion and the rotary shaft enabling the weight block and the rotary shaft to be coupled firmly.

### FIELD OF THE INVENTION

The invention relates to a micro vibrating motor, more particularly to a micro vibrating motor having a weld portion enabling a weight block and a rotary shaft thereof to be coupled firmly.

### BACKGROUND OF THE INVENTION

FIG. 1 shows a micro vibrating type motor for mounting in conventional light equipment and telecommunication equipment. The vibrating motor includes a motor 1. A weight block 2 is provided on a rotary shaft 10 disposed at one end edge of the motor 1 at a suitable position. The weight block 2 on the rotary shaft 10 is in an offset state such that, during operation of the motor 1, the rotary shaft 10 can bring the weight block 2 to rotate therewith to enable the motor 1 to generate a vibrating force.

Since the motor 1 is mounted in the light equipment and telecommunication device, the motor 1 must be sized to be smaller than the light equipment and telecommunication device. For instance, the motor of a mobile phone is smaller than 6 mm, and the diameter of the rotary shaft 10 of the motor 1 is less than 1 mm. Therefore, the micro vibrating motor cannot be secured by threaded engagement as in conventional large motors, and the technique of connecting the rotary shaft of a large motor with the weight block provided on the rotary shaft of the large motor cannot be applied to the micro vibrating motor.

Therefore, referring to FIG. 2, the coupling of the weight block to the rotary shaft of the conventional micro vibrating motor is that the weight block 2 is provided with a coupling portion 20. The largest dimension of the internal diameter of the coupling portion 20 is slightly greater than the external diameter of the rotary shaft 10 so as to facilitate mounting of the rotary shaft 10 in the coupling portion 20. The surface of the coupling portion 20 is knocked or pressed such that the coupling portion 20 retracts inwardly to thereby clamp the rotary shaft 10 in the coupling portion 20. Hence, the rotary shaft 10 and weight block 20 can be coupled together.

However, during the process of knocking or pressing of the weight block 2, the rotary shaft 10 may be caused to bent or deform so that the rotary 10 is offset. As such, the rotary shaft 10 cannot rotate smoothly during operation and may even break.

Furthermore, the size of the weight block 2 is relatively small, and is generally formed from metal material. Therefore, the knock head used to punch the weight block 2 is not large, and is made from a material that has a hardness greater than that of the weight block. Therefore, during the process of knocking the weight block 2, the knock head may easily break or even damage the weight block 2 and motor 1.

In addition, the coupling of the rotary shaft 10 and weight block 2 by knocking or pressing cannot make the rotary shaft 10 and weight block 2 coupled in a stable manner. If the rotary shaft 10 and weight block 2 are coupled by knocking, the rotary shaft 10 and weight block 2 will join only at the knocked positions where there are only point-to-point contacts. It can therefore be seen that there are many clearances between the rotary shaft 10 and weight block 2, and the coupling of the rotary shaft 10 and weight block 2 is not firm. During rotation of the rotary shaft 10, the weight block 2 may slip from the rotary shaft 10 and may as a result cause damage to components in the light equipment and telecommunications device.

### SUMMARY OF THE INVENTION

The primary object of the invention is to provide a micro vibrating motor which includes a weight block. The weight block has a coupling portion provided thereon. The coupling portion is provided to receive a rotary shaft disposed at an end edge of a motor. A weld portion is provided at connecting edges of the coupling portion and the rotary shaft. The weld portion enables the weight block and the rotary shaft to be coupled firmly.

### BRIEF DESCRIPTION OF THE DRAWINGS

The foregoing and other features and advantages of the present invention will be more clearly understood from the following detailed description and the accompanying drawings, in which,

FIG. 1 is a schematic view of a conventional weight block and a rotary shaft of a motor prior to knocking or pressing;

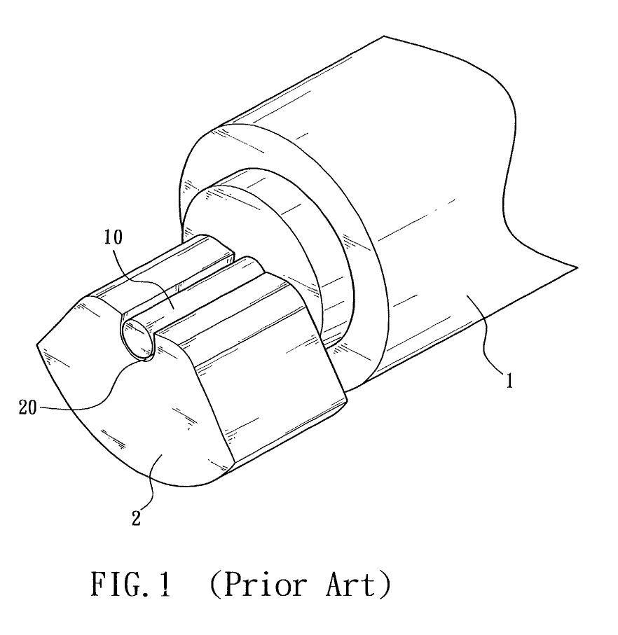

FIG. 2 is a schematic view of the conventional weight block after knocking or pressing, showing the weight block coupling with the rotary shaft of the motor;

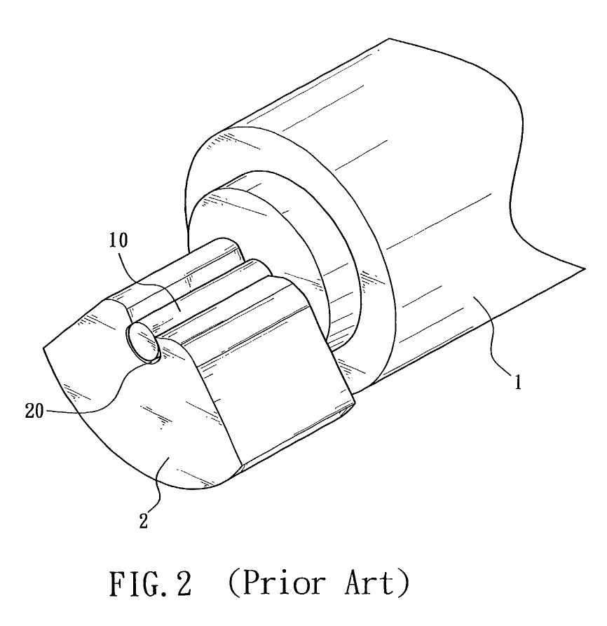

FIG. 3 is a schematic view of an embodiment of the present invention in part; and

FIG. 4 is a schematic view of another preferred embodiment of the present invention in part.

### DETAILED DESCRIPTION OF THE PREFERRED EMBODIMENTS

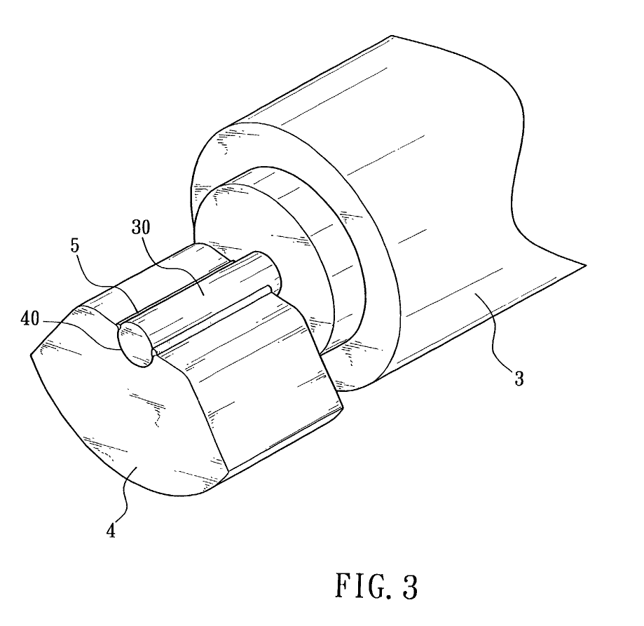

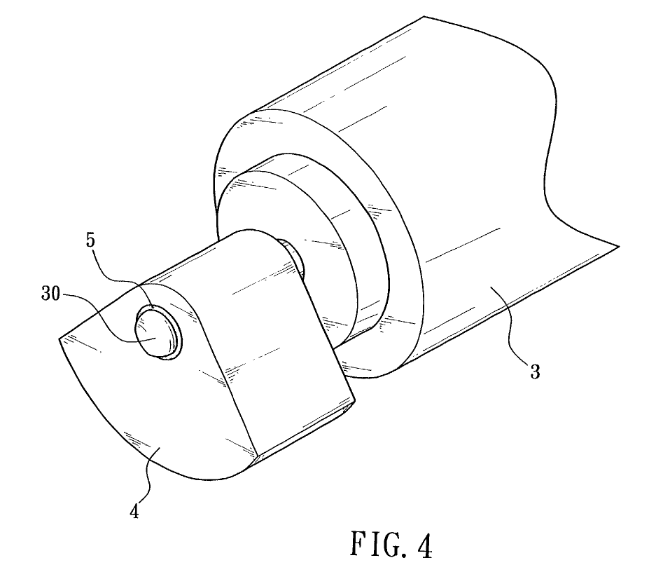

Referring to FIGS. 3 and 4, a micro vibrating motor according to the present invention includes a motor 3. One end of the motor 3 is provided with a rotary shaft 30. A weight block 4 is provided with a coupling portion 40 for coupling with the rotary shaft 30. The weight block 4 on the rotary shaft 30 is in an offset state. The weld portion 5 is provided on the edge of the coupling portion 40 which joins the rotary shaft 30. The weld portion 5 enables the weight block 4 to be firmly coupled with the rotary shaft 30.

In the invention, the motor 3 is sized to be less than 6 mm, while the diameter of the rotary shaft 30 is less than 1 mm.

In the preferred embodiment of the present invention, referring to FIG. 3, the weight block 4 has a fan shape, and the coupling portion 40 is provided on a relatively small curved surface of the weight block 4. The weld portion 5 is elongated and is disposed at the edge of the coupling portion 40 on the curved surface and connected to the rotary shaft 30 such that the elongated weld portion 5 couples the weight block 4 and the rotary shaft 30 together. The coupling area of the weight block 2 and rotary shaft 30 is far larger than that achieved in the prior art in which the weight block and rotary shaft are coupled by point contact. Thus, the weight block 4 and rotary shaft 30 can be firmly coupled.

In another preferred embodiment of the invention, referring to FIG. 4, the weight block 4 is fan-shaped, and the coupling portion 40 is a through hole. The through hole 40 extends from one end of the weight block 4 to the other end, and has a diameter dimensioned to receive the rotary shaft 30. The weld portion 5 is substantially curved and is provided on one end of the coupling portion 40 distal from the motor 3 and at the edge connected to the rotary shaft 30. By means of the curved weld portion 5, the weight block 4 and the rotary shaft 30 can be coupled. Hence, the coupling area of the weight block 4 and the rotary shaft 30 is far larger than that in the prior art in which the weight block and the rotary shaft are coupled by point contact. Thus, the weight block 4 and the rotary shaft 30 can be coupled firmly.

In these embodiments, the connecting edges of the coupling portion 40 and the rotary shaft 30 can be melted so that the coupling portion 40 and the rotary shaft 30 are partially melted to form the weld portion 5. Hence, the rotary shaft 30 will not bend or deform. During rotation, the rotary shaft 30 can smoothly rotate and will not easily break.

Furthermore, the problem associated with the breaking of the knocking head and damage of the weight block and motor during the knocking process in the prior art can be eliminated.

In addition, the coupling portion 40 of the weight block 4 is so configured as to insertably receive the rotary shaft 30 such that there is not any clearance between the rotary shaft 30 and the coupling portion 40. Furthermore, the use of laser welding to couple the weight block 4 and the rotary shaft 30 can make them coupled tightly together. As laser welding is a precision processing method, the coupling between the weight block 4 and the rotary shaft 30 can be firmer compared to the use of knocking or pressing in the prior art.

What is claimed is:

1. A micro vibrating motor comprising:
a motor, one end of said motor having a rotary shaft disposed thereon;
a weight block, said weight block having a coupling portion provided thereon to insertably receive said rotary shaft such that, after said weight block is mounted on said rotary shaft, said weight block on said rotary shaft is in an offset state, a weld portion being disposed at an edge of said coupling portion that is connected to said rotary shaft so as to enable said weight block and said rotary shaft to be coupled together.

2. The micro vibrating motor as claimed in claim 1, wherein said motor has a size less than 6 mm, and said rotary shaft has a diameter less than 1 mm.

3. The micro vibrating motor as claimed in claim 1, wherein said weight block is fan-shaped, said coupling portion being provided on a relatively small curved surface of said weight block, said weld portion being elongated and being provided at the edge of said coupling portion on said curved surface and connected to said rotary shaft, said elongated weld portion enabling said weight block and said rotary shaft to be coupled together.

4. The micro vibrating motor as claimed in claim 1, wherein said weight block is fan-shaped, and said coupling portion is a through hole that extends from one end of said weight block to the other end and that has a diameter dimensioned to receive said rotary shaft, said weld portion being generally curved and being provided on one end of said coupling portion that is distal from said motor and that has an edge connected to said rotary shaft, said curved weld portion enabling said weight block and said rotary shaft to be coupled together.
